(19) United States
(12) Patent Application Publication
(10) Pub. No.: US 2004/0136481 A1
(43) Pub. Date: Jul. 15, 2004

(54) Method of estimating fading in a pilot channel

(76) Inventors: Chang Qing Xu, Singapore (SG); Ju Yan Pan, Singapore (SG); Hiroshi Katsuragawa, Singapore (SG)

Correspondence Address: HOWREY SIMON ARNOLD & WHITE, LLP, BOX 34, 301 RAVENSWOOD AVE., MENLO PARK, CA, 94025, US

(21) Appl. No.: 10/652,191

(22) Filed: Aug. 29, 2003

(30) Foreign Application Priority Data
Sep. 6, 2002 (SG) 200205452-6

(51) Int. Cl. H04B 1/10

(52) U.S. Cl. 375/350

(57) ABSTRACT

A method of estimating fading of a modulated signal transmitted through a pilot channel using a digital filter 20 is disclosed herein. The signal is divided into frames each of a plurality of symbols Yᵢ and the method comprises the step of deriving a moving average of the symbols received in each frame, of the form

$${x}_{n} = ( ( n - 1 ) / n ) {x}_{n - 1} + 1 / R n ( {\sum }_{i = R ( n - 1 ) + 1}^{R n} {y}_{i} )$$

where xₙ is the moving average of the symbols so far received for the frame, xₙ₋₁ is a previously calculated moving average, R is the number of received symbols since the previous average was calculated and n is the number of averages calculated per frame, each average providing a fading estimate for the frame.

### BACKGROUND AND FIELD OF THE INVENTION

This invention relates to a method of estimating fading in a pilot channel, more particularly but not exclusively, for estimating fading of multi-level modulated signals.

In wireless communications systems, the wireless channel poses a great challenge as a medium for reliable high speed communications. To increase the speed of transmitting video, voice or data over a channel, different modulation techniques have been devised to cater to different application requirements. For example, binary signalling which uses two voltage levels or symbols to represent the digital data was the primary technique in the early days of digital technology and is still being used today. With demand for higher transmission rate multi-level signalling was introduced so that more binary data can be represented by each voltage level or symbol.

An example of a multi-level signalling modulation technique is multilevel quadrature amplitude modulation (M-QAM). Examples of M-QAM include 16 QAM, 64 QAM or 256 QAM. In M-QAM modulation, the transmitted signal over the wireless channel is subject to multipath distortion which significantly affects the amplitude and phase of the transmitted signal. Since demodulation of a multi-level signal is very much dependent on the detection of the amplitude and the phase of the signal, the estimation of fading caused by the channel is critical for a decoding calculation at the receiver end to demodulate the transmitted signal.

Typically, such an estimation is obtained by sending a known pilot signal through a pilot channel which is used concurrently with a data channel (the channel being used to transmit the actual information). In this way, the pilot signal is subjected to the same amount and type of interference as the actual transmitted data. The transmitted pilot signal is known and can be fixed for example, to all binary ones or zeros so that this “reference” signal can be used for estimating fading experienced by the actual transmitted data.

A pilot channel filter is typically employed at the receiver end to “smoothen” the demodulated pilot signal. This smoothing process is needed since the pilot signal is also subjected to distortion caused by white noise and other interference, in addition to fading. The pilot channel filter is thus used to remove such unwanted interference so as to obtain a more accurate fading estimate.

Such a pilot filter may produce reasonably reliable fading estimates for modulation techniques such as QPSK. However, for higher order modulation techniques such as M-QAM, the output signals still possess a high variance which does not allow an accurate estimation of the fading required for demodulation of multilevel modulated signals.

It is an object of the invention to provide for a method of estimating fading which alleviates this disadvantage of the prior art.

### SUMMARY OF THE INVENTION

In a first aspect of the invention, there is provided a method of estimating fading of a modulated signal transmitted through a pilot channel using a digital filter, the signal being divided into frames each of a plurality of symbols, the method comprising the step of deriving a moving average of the symbols received in each frame, of the form

$${x}_{n} = ( ( n - 1 ) / n ) {x}_{n - 1} + 1 / R n ( {\sum }_{i = R ( n - 1 ) + 1}^{R n} {y}_{i} )$$

where xₙ is the moving average of the symbols so far received for the frame, xₙ₋₁ is a previously calculated moving average, R is the number of received symbols since the previous average was calculated and n is the number of averages calculated per frame, each average providing a fading estimate for the frame.

Typically, the number of received symbols R is dependent on a desired output frequency of the digital filter and the number of averages n is derived from an input frequency of the digital filter divided by a desired output frequency of the digital filter.

Preferably, the number of received symbols R is two or three and the calculation of the moving average in a frame is performed no more than five times.

Preferably, the signal is modulated using multi-level signalling and the digital filter used in the method is an IIR filter.

An advantage of the described embodiment of the invention is that a more accurate estimation of the channel fading can be obtained which can be used during the demodulation process, particularly if the data is modulated using multi-level signalling.

### BRIEF DESCRIPTION OF THE DRAWINGS

An embodiment of the invention will now be described, by way of example, with reference to the accompanying drawings in which,

FIG. 1 is a block diagram of a conventional IIR digital filter used in a pilot channel; and

FIG. 2 is a block diagram of a modified IIR digital filter according to the present invention.

### DETAILED DESCRIPTION OF THE PREFERRED EMBODIMENT

An important application of pilot channel filtering is in 3GPP WCDMA high speed downlink packet access (HSDPA¹) and thus a problem of the conventional filter in the prior art and a solution proposed by the present invention will be described with reference to such an application.

In HSDPA, the data signals may be coded using 16 QAM technique. The separate pilot signal transmitted over the pilot channel, also known as common pilot channel² is pre-defined and may be a string of ones which are QPSK modulated. QPSK is chosen because the transmission and reception of QPSK is relatively easier than QAM and the accuracy of the channel estimation may be more accurate by using this simpler modulation technique. At the receiver end, after all the necessary processing and demodulation, thirty symbols per frame (one frame for HSDPA has a 2 ms interval) of decoded pilot channel signals are obtained. Ideally, these pilot symbols should be corrupted by multipath fading only in order to obtain an accurate fading estimate. However, in reality, the pilot symbols are also subject to other types of interference resulting in “coarse” symbols especially in a slow fading channel.

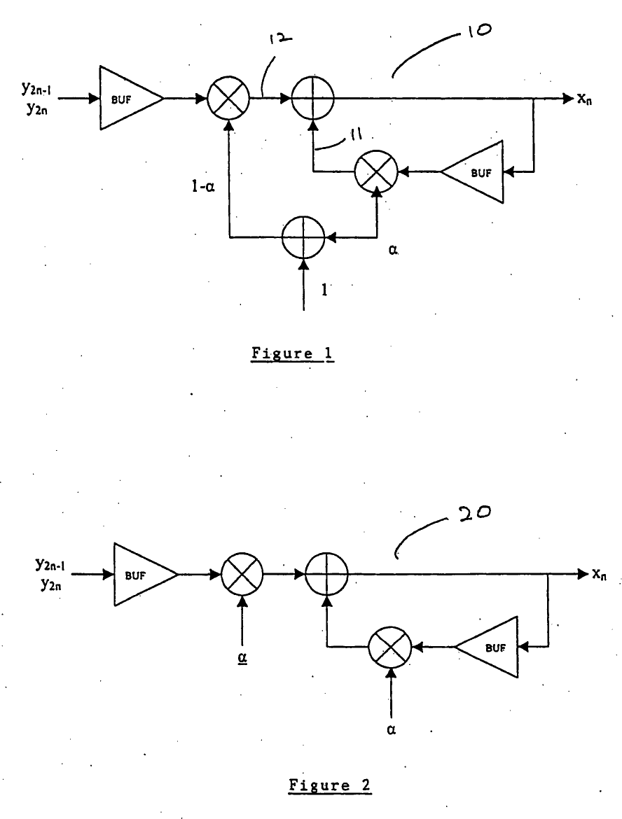

A conventional IIR filter 10 as shown in FIG. 1 is used to alleviate this problem. The thirty symbols (i.e. input frequency of 30/2 ms=15 Khz) are smoothed using the IIR filter 10 to remove the “unwanted” interference described earlier. The filter 10 sums two sets of signals 11,12 which are weighted by two constant coefficients (i.e. two taps) of α and 1−α, where α<1. The first signal 11 is a stored value of the previous filter output symbol xₙ, and the second signal 12 is the sum of a group of the incoming thirty symbols. The size of the group depends on the desired filter output frequency, for example, if the required output frequency is 7.5 Khz, the size of the group would be two symbols and thus the group consists of input symbols y₂ₙ₋₁ and y₂ₙ.

The output of the IIR filter of FIG. 1 can be represented by:

xₙ=axₙ₋₁+(1−α) (y₂ₙ₋₁+y₂ₙ) (1)

The constant coefficient α is chosen such that the output signals of the filter do not deviate too much from each other. Typically, the choice of the coefficient α also depends on a desired output frequency response of the filter.

Using the above method, IIR filtering is a simple and effective way to smooth the thirty pilot symbols which is adequate if the data signals are modulated using QPSK. However, in HSDPA, a 16 QAM data channel is used and it has been found that the IIR filter 10 of the prior art is not adequate to produce an accurate fading estimate of the received pilot signals.

The described embodiment of the present invention provides a method of producing a more accurate fading estimate, especially for pilot symbols transmitted through a slow fading pilot channel.

For a slow fading (i.e. slow in relative to the filter output frequency of 7.5 Khz) channel, the values of the thirty symbols are expected to increase or decrease gradually and in small amounts. Therefore, the mean of the 30 symbols would be a good estimate of the fading which can be expressed as:

xₙ=(y₁+y₂+. . .+y₂ₙ)/2n, (2)

where xₙ is the filter output at nth symbol, yₙ is the input symbol and n={1, 2, 3, . . . , 15} which is the number of averages calculated per frame.

From (2), the moving average of the output xₙ can be obtained as:

xₙ=((n−1)/n)xₙ₋₁+(½n)(y₂ₙ₋₁+y₂ₙ), (3)

which processes two received symbols y₂ₙ₋₁ and y₂ₙ at the same time and xₙ₋₁ is a previously calculated moving average.

It is convenient to express the coefficients of xₙ₋₁ and (y₂ₙ₋₁+y₂ₙ) as two variables a and a to obtain a more accurate moving average where

a=(n−1)/n

a=½n.

Table 1 lists the values of a and a for all the 15 filter output sequences.

TABLE 1

| n | α | α |
|---|---|---|
| 1 | 0 | 0.5000 |
| 2 | 0.5000 | 0.2500 |
| 3 | 0.6667 | 0.1667 |
| 4 | 0.7500 | 0.1250 |
| 5 | 0.8000 | 0.1000 |
| 6 | 0.8333 | 0.0833 |
| 7 | 0.8571 | 0.0714 |
| 8 | 0.8750 | 0.0625 |
| 9 | 0.8889 | 0.0556 |
| 10 | 0.9000 | 0.0500 |
| 11 | 0.9091 | 0.0455 |
| 12 | 0.9167 | 0.0417 |
| 13 | 0.9231 | 0.0385 |
| 14 | 0.9286 | 0.0357 |
| 15 | 0.9333 | 0.0333 |

As observed from table 1, the values of the coefficients a and a are varied for each group of received symbols.

To simplify the computation further, examining table 1 reveals that the coefficients a and a between n=5 and n=15 are very similar, Therefore, alternatively, it is possible to use only five values of each coefficient to produce reliable output filter symbols for all the input symbols. Table 2 lists the five pairs of coefficients. The first four pairs are the same as in Table 1, but the fifth pair is the average of coefficients 5 to 15.

TABLE 2

| n | α | α |
|---|---|---|
| 1 | 0 | 0.5000 |
| 2 | 0.5000 | 0.2500 |
| 3 | 0.6667 | 0.1667 |
| 4 | 0.7500 | 0.1250 |
| 5 (and | 0.9765 | 0.0518 |
| above) | | |

FIG. 2 shows the architecture of equation (3) according to the preferred embodiment of the present invention. For a different n, a different pair of a and a coefficients according to Table 2 are loaded to a modified IIR filter 20 to obtain a moving average of the received symbols to provide the fading estimates of the symbols at a rate of 7.5 Khz.

Table 3 shows the simulation results between a typical conventional IIR filter 10 using a constant α of 1/16 and the modified IIR filter 20 according to the invention as applied in a HSDPA system.

TABLE 3

| Parameter | Value |
|---|---|
| Carrier frequency | 2 Ghz |
| Chip rate | 3.84 M |
| Propagation conditions | Rayleigh Fading with |
| | speed of 3 km/h |
| Number of multipath signals | 2, 3 |
| Power of multipath signals | [0, −10], [0, 0, 0] (dB) |
| Delay of multipath signals | [0, 4], [0 4, 77] (chip) |
| Data combining for Multipath | RAKE combining |
| Frame length | 2 ms |
| Spreading factor | 16 |
| Number of Multicodes | 5 |
| lor/loc | Variable |
| Modulations | 16QAM with coding rate of ¾ |
| Channel coding | Turbo Cod (PCCC) 1/3 |
| Channel estimation | CPICH |
| Power of CPICH (Common Pilot | 10% of the total |
| Channel) | transmission power |
| Max. no. of iterations for Turbo Coder | 6 |
| Metric for Turbo Coder | Max-log MAP |
| Input to Turbo Decoder | Soft |
| HARQ | Chase Combining |
| Max. no of transmission attempt | 4 |

The results of the simulation under a 2-path fading and 3-path fading are presented in Table 4 which lists the maximum throughput achievable for the two different pilot filters under these two different fading conditions.

TABLE 4

| | 2-path case | 3-path case |
|---|---|---|
| Max. throughput with | 40% | 20% |
| prior art IIR filter | | |
| Max. throughput with | 95% | 90% |
| modified IIR filer | | |

From the above results, it can be shown that the proposed method allows a more accurate estimation of the fading amplitudes using the modified IIR filter 20 as compared to the conventional IIR filter 10. With multi-level signalling gaining recognition and popularity, the described embodiment can be used to obtain an accurate fading estimate so that the demodulation process can recover the modulated signals accurately.

The embodiment described should not be construed as limitative. For example, the invention can be modified to process or recalculate the moving average of every three received symbols at a time depending on the desired pilot filter output frequency so that if the output frequency is changed from 7.5 Khz to 5 Khz, equation (3) becomes:

xₙ=((n−1)/n)xₙ₋₁+(⅓n)(y₃ₙ₋₂+y₃ₙ₋₁+y₃ₙ) (4)

where n={1,2,3 . . . , 10} and

where a=(n−1)/n

a=⅓n

In this way, the moving average is recalculated every three received symbols compared with two in the preferred embodiment. The values of the coefficients a and a are thus adjusted accordingly since they are dependent on the n^{th} average calculated per frame as shown above. Therefore, the averaging can be extended to a larger number of symbols instead of just two.

Accordingly, equations (3) and (4) can be further generalised as:

$${x}_{n} = ( ( n - 1 ) / n ) {x}_{n - 1} + 1 / R n ( {\sum }_{i = R ( n - 1 ) + 1}^{R n} {y}_{i} )$$

where R is the number of received symbols since the previous average was calculated.

Increasing the number of symbols in the averaging operation improves the channel estimation since accuracy is improved but this will reduce the output filter frequency. This may be particularly useful if the fading in the channel has a smaller time-variant.

In the described embodiment, two filter coefficients a and a are used to control the filter characteristics. However, this number may vary for different systems. Having more filter coefficients improves the filter response and thus provides a better channel estimation. The downside is that the hardware implementation of the modified IIR filter 20 is more complex since more taps are required to cater to the increased filter coefficients. Therefore, when designing a pilot channel, the accuracy of the channel estimation and the hardware complexity of the filter should be considered.

In addition, the described embodiment uses 16 QAM as an example of a multi-level modulation technique for the data channel. However, the invention is also applicable to other “high” order modulation schemes such as 64 QAM, 256 QAM, M-PSK and M-ASK.

Having now fully described the invention, it should be apparent to one of ordinary skill in the art that many modifications can be made hereto without departing from the scope as claimed.

### REFERENCES

1) “High speed downlink packet access (HSDPA): Overall UTRAN description (Release 5)”, 3 GPP Technical Report TR 25.855, v.5.0.0 (2001-09)

2) “Physical channels and mapping of transport channels onto physical channels (FDD) (Release 1999)”, 3GPP Technical Report TS 25.211, v3.0.0 (2000-06)

1. A method of estimating fading of a modulated signal transmitted through a pilot channel using a digital filter, the signal being divided into frames each of a plurality of symbols, the method comprising the step of deriving a moving average of the symbols received in each frame, of the form
$${x}_{n} = ( ( n - 1 ) / n ) {x}_{n - 1} + 1 / R n ( {\sum }_{i = R ( n - 1 ) + 1}^{R n} {y}_{i} )$$
where xₙ is the moving average of the symbols so far received for the frame, xₙ₋₁ is a previously calculated moving average, R is the number of received symbols since the previous average was calculated and n is the number of averages calculated per frame, each average providing a fading estimate for the frame.

2. A method according to claim 1, wherein R is dependent on a desired output frequency of the digital filter.

3. A method according to claim 1, wherein the number of averages n is derived from an input frequency of the digital filter divided by a desired output frequency of the digital filter.

4. A method according to claim 1, wherein R is two symbols.

5. A method according to claim 1, wherein R is three symbols.

6. A method according to claim 1, wherein the calculation of the moving average in a frame is performed no more than five times.

7. A method according to claim 1, wherein the signal is modulated using multi-level signalling.

8. A method according to claim 1, wherein the digital filter is an IIR filter.
